(19) United States
(12) Patent Application Publication
(10) Pub. No.: US 2002/0195169 A1
(43) Pub. Date: Dec. 26, 2002

(54) Method of fabricating bamboo slats for bamboo blinds

(76) Inventor: Feng-Yuan chen, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/888,404

(22) Filed: Jun. 26, 2001

(51) Int. Cl. B27D 1/00; B27F 1/00; B27G 11/00; B27K 1/00

(52) U.S. Cl. 144/347

(57) ABSTRACT

A method for fabricating bamboo blind slats is disclosed. The steps include splitting a selected bamboo stem into several bamboo strips, removing the skins and joints from the bamboo strips before being disinfected and dried and then trimming them to fine bamboo strips. Further at least two bamboo strips are indented or truncated to joint with the corresponding ends, and then is trimmed to a fine jointed bamboo strip. A bamboo plate is obtained by joining fine jointed bamboo strips and/or the fine bamboo strips together in conjunction with a pneumatic press, and then is trimmed and polished. After slicing the bamboo plate into several bamboo slats, the bamboo slats need to be polished before covering a base coating, polished again before covering a face coating. Finally the bamboo slats are punched two cord holes to be used for making a Venetian blind. The method achieves to increase the utilization of bamboo material by combining the processed divided bamboo strips to obtain more extensible, highly stable and anti-yielding bamboo slats

### BACKGROUND OF THE INVENTION

1. Field of the Invention

The present invention relates to a method for fabricating bamboo blind slats, and more particularly, to the method capable of increasing the utilization of bamboo material by joining the processed divided bamboo strips to obtain more extensible, highly stable and anti-yielding bamboo slats for a Venetian blind.

2. Description of the Related Art

Conventionally, the slats for Venetian blinds are made from wooden material for the advantages of fine touch and good outer appearance. However, because it happened to excessively deforest all over the world in recent years, it is difficult to obtain sufficient supplies of wooden material. Additionally, there need ten years in average to grow trees so that the cost of wooden material has become much higher and higher. Furthermore, wooden blinds have short lifetime because the fiber structure of wooden slats cannot bear high pressing. One the other hand, polyvinyl chloride (PC) and aluminum are conventionally substitutions used for making slats for Venetian blinds. However, the fabrication of these kinds of slats will cause pollution. It is not good for the environment.

There are lots of U.S. Patents such as U.S. Pat. Nos. 5,896,903, 5,967,207, 6,098,680 and 6,192,949 which disclose methods about manufacturing bamboo blind slats. However, the length of divided bamboo strips always limits the process to enhance the utilization of bamboo material. Thus, the improvement is existed.

### SUMMARY OF THE INVENTION

It is therefore an objective of the present invention to provide a method for fabricating bamboo blind slats including: (i) selecting a preferable straight bamboo, cutting the selected bamboo stem in a predetermined length B, and splitting the bamboo into several strips with a width A; (ii) removing the skins and joints from two opposite longitudinal surface of the bamboo strips, disinfecting the dressed the bamboo strips by boiling them in a diluted hydrogen peroxide solution or by a sulfur fume for about 8 hours, drying the processed bamboo strips by baking in about 50 to 60° C. for about 48 hours, and then trimming around the bamboo strips into fine ones; (iii) indenting or truncating and coating an adhesive on one end or both ends of the bamboo strips to have two indented/truncated bamboo strips being jointed together, trimming the jointed bamboo strips and then covering an adhesive coating on two opposite transverse surface, stacking the jointed and trimmed bamboo strips one by one in a staggered arrangement (i.e. the bamboo strips therebetween will not align in the stacking direction), and adhered them together in conjunction with a pneumatic press to form a bamboo plate; (iv) trimming the bamboo plate on surfaces and then polishing by a polisher, slitting the polished bamboo plate into several bamboo blocks with a width C in transverse direction and then slicing the bamboo plate into several bamboo slats with a thickness E such as about 0.6 to 2.7 mm, and polishing the bamboo slat before being covered with a base coating obtained from a resin, surfacer and digestive fiber mixture and then polishing again before covering the base coated bamboo slats with a face coating obtained from a resin, surfacer, digestive fiber and organic solvent mixture such that the hardness of the finished bamboo slat is gained about within 2H to 4H; and (v) punching the bamboo slat to provide two through holes with a distance F such as about 140 to 150 mm from the edge and assembling a Venetian blind by accommodating the pull cords into the through holes.

This and other objectives of the present invention will no doubt become obvious to those of ordinary skill in the art after having read the following detailed description of the preferred embodiment which is illustrated in the various drawings and figures.

### BRIEF DESCRIPTION OF THE DRAWINGS

FIGS. 1 to 3 is a flow chart of the process for manufacturing bamboo blind slats according the present invention;

FIG. 4 shows a perspective view of a selected bamboo stem being split into several bamboo strips according to the method of the present invention;

FIG. 5 shows a perspective view of dressing one of the bamboo strips of FIG. 4;

FIG. 6 shows a perspective view of further processing the dressed bamboo strip of FIG. 5;

FIG. 7A shows a schematic diagram of aligning the processed bamboo strips of FIG. 6 by indenting one end or both ends thereof;

FIG. 7B shows a schematic diagram of aligning the processed bamboo strips of FIG. 6 by truncating one end or both ends thereof;

FIG. 8A shows a schematic diagram of jointing the indented bamboo strips of FIG. 7A;

FIG. 8B shows a schematic diagram of jointing the truncated bamboo strips of FIG. 7B;

FIG. 9A shows a perspective view of stacking together the jointed bamboo strip of FIG. 8A in conjunction with a pneumatic press to form a bamboo plate;

FIG. 9B shows a perspective view of stacking together the jointed bamboo strip of FIG. 8B in conjunction with a pneumatic press to form a bamboo plate;

FIG. 10 shows a perspective view of cutting the bamboo plate into bamboo blocks according to the method of the present invention;

FIG. 11 shows a perspective view of slicing the bamboo block into bamboo slats according to the method of the present invention;

FIG. 12 shows a perspective view of punching the bamboo slat according to the method of the present invention;

FIG. 13 shows a perspective view of a Venetian blind constructing with several bamboo slats made by the method of the present invention;

FIG. 14 shows a perspective view of another Venetian blind constructing with several bamboo slats made by the method of the present invention;

FIGS. 15 to 17 show schematic diagrams of different engagements between two indented bamboo strips according to another preferred embodiments; and

FIGS. 18 and 19 show schematic diagrams of the conjunctive bamboo plates in different arrangement according to another preferred embodiments.

### DETAILED DESCRIPTION OF THE PREFERRED EMBODIMENT

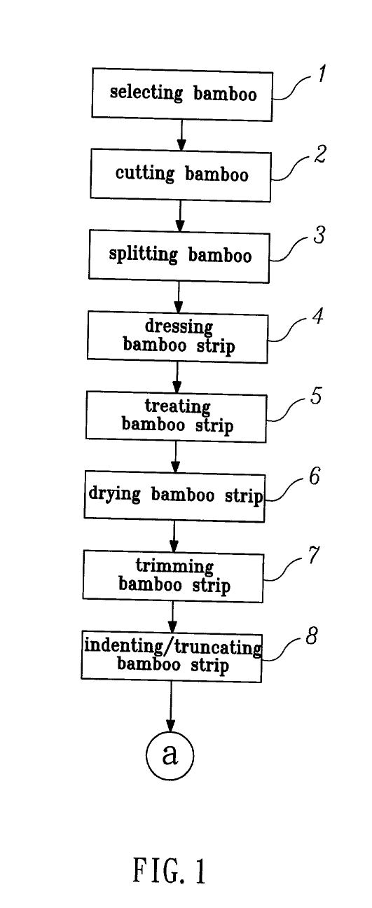

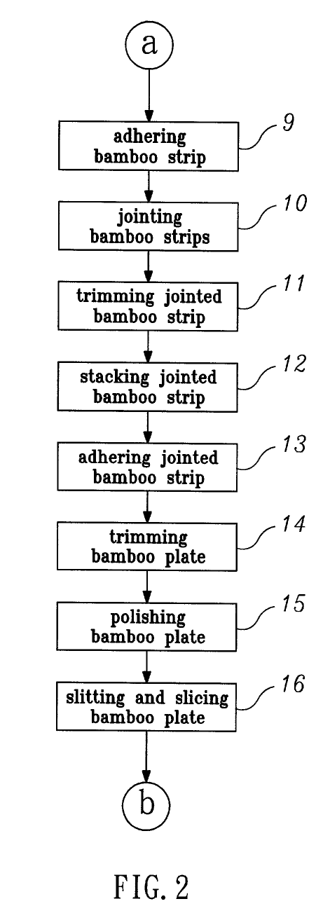

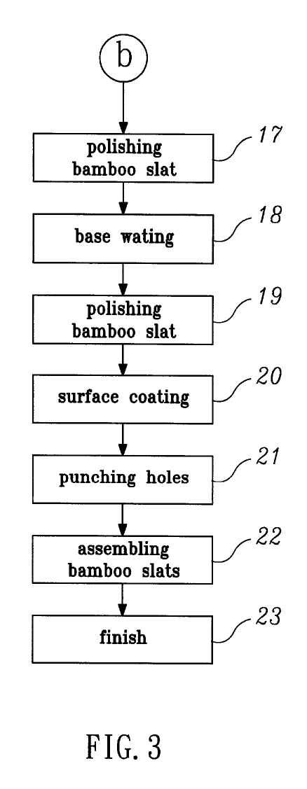

Please refer to FIGS. 1, 2 and 3, a bamboo blind of bamboo slats fabricating method according the present invention includes the steps as follows.

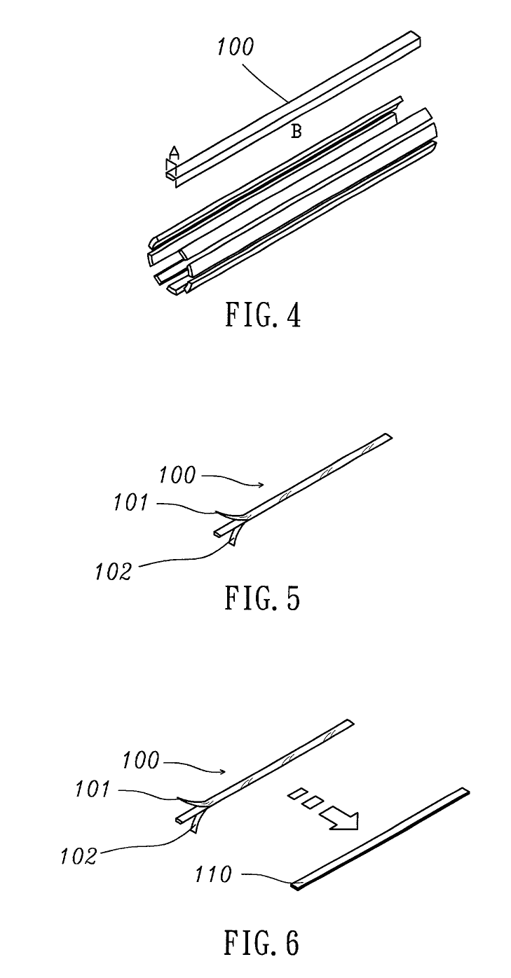

(i) In step 1, a preferable straight bamboo is selected, which preferably has a 4 to 5-year growth period, its stem is above 9 inches in diameter and about 10 to 26 mm in thickness, and its root is above 10 cm in length. In step 2, the selected bamboo is then cut in a predetermined length B (as shown in FIG. 4) which usually determines and limits the size in one direction while obtaining a bamboo plate to produce the bamboo slats in convention. However, in the present invention, the length in longitudinal direction of the bamboo plate according to following description can be extended and will not limited by this length B. In step 3, the cut bamboo is split into several bamboo strips 100 with a width A about 20 to 30 mm.

(ii) In step 4, the bamboo strip 100 is dressed by removing the skins and joints 101 and 102 from two opposite longitudinal surface thereof. The dressed bamboo strip 110 (as shown in FIG. 6) is then disinfected to an antiseptic and anti-wormed treatment in step 5 by boiling the bamboo strips 110 in a diluted hydrogen peroxide solution or processing in a sulfur fume for about 8 hours. The processed bamboo strip 110 is further in step 6 dried by baking in about 50 to 60° C. for about 48 hours and then is trimmed around into a fine one.

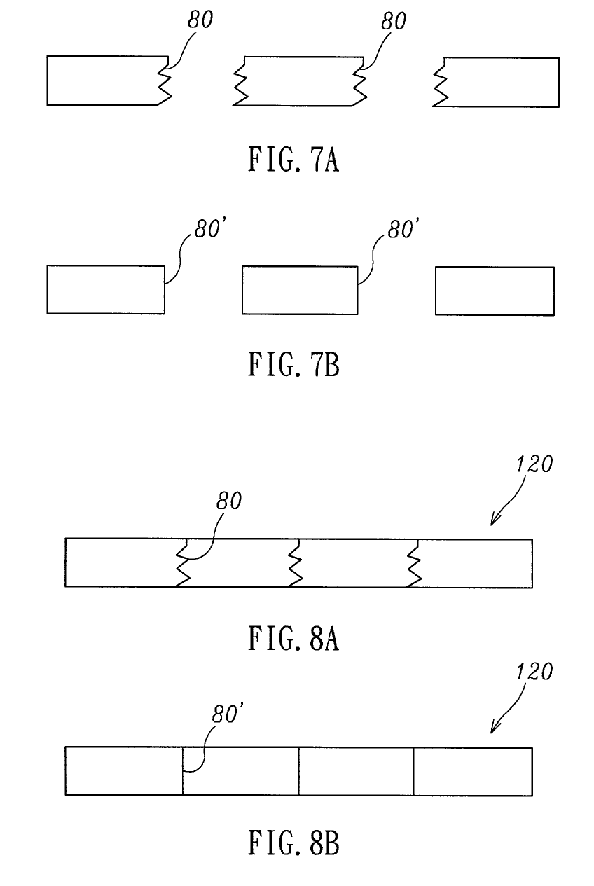

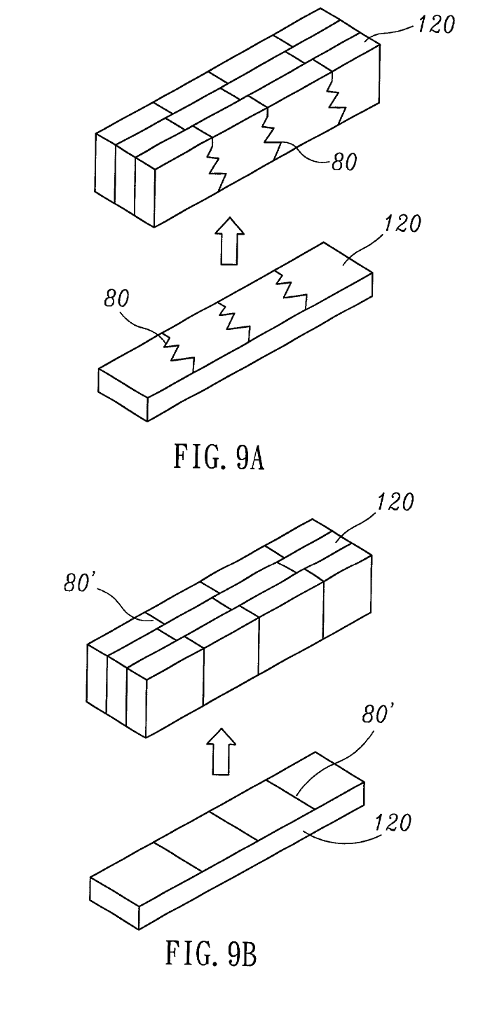

(iii) From steps 8 to 10, the fine bamboo strip 110 is indented or truncated (as shown in FIGS. 7A and 7B) and then are coated an adhesive, such as mixing acrylic powder with resin, on one end or both ends 80 or 80′ to have two bamboo strips being jointed together (as shown in FIGS. 8A and 8B). It is obviously to show that in one view of this procedure, one can joint several shorter bamboo strips (i.e. having shorter length than length B as shown in FIG. 4) to reach a predetermined length in longitudinal direction, thus more bamboo material can be selected to be used for fabrication so that increases the utilization of the bamboo material. On the other hand, if one uses traditional bamboo strips (i.e. having the same length B as shown in FIG. 4), it can obtain a much longer jointed bamboo strip to be extended in longitudinal direction. The jointed bamboo strip 120 is trimmed and then covered with an adhesive coating on two opposite transverse surface in step 11. Further, in step 12, several jointed bamboo strips are stacked one by one in a staggered arrangement (i.e. the bamboo strips therebetween will not align in the stacking direction) and adhered together in conjunction with a pneumatic press in step 13 to form a bamboo plate 130 (as shown in FIG. 9).

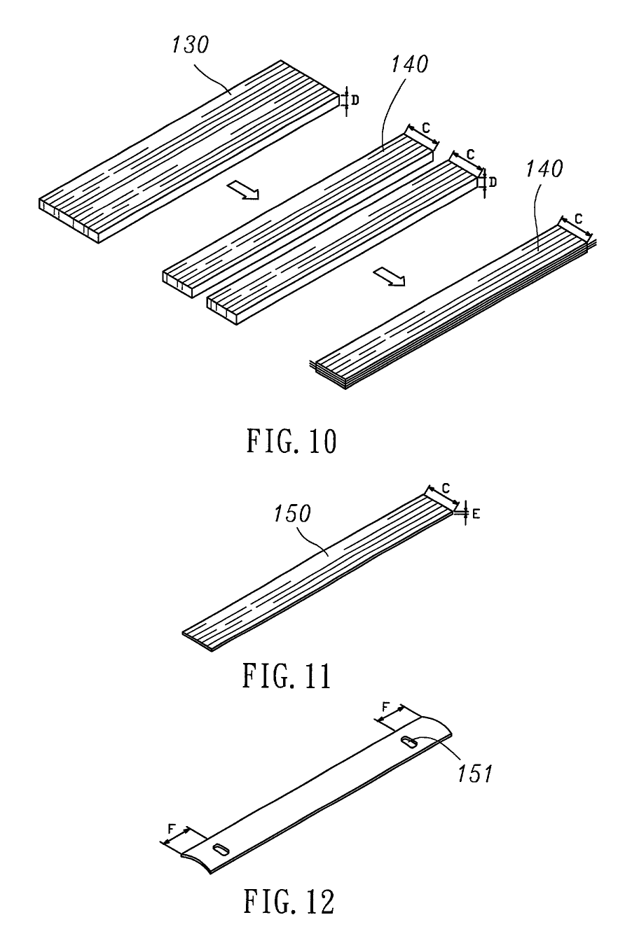

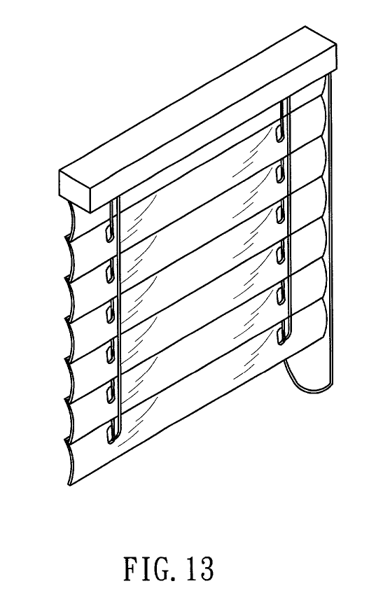

(iv) In steps 14 and 15, the bamboo plate 130 is trimmed again on surfaces and then is polished by a polisher. Thereafter, the polished bamboo plate is slit into several bamboo blocks 140 with a width C in transverse direction (as shown in FIG. 10), and then the bamboo plate 140 is sliced into several bamboo slats 150 with a thickness E such as about 0.6 to 2.7 mm, as shown in FIG. 11 in step 16. The bamboo slat 150 is polished in step 17 before being covered with a base coating obtained from a resin, surfacer and digestive fiber mixture (step 18), and then is polished again (step 19) before covering the base coated bamboo slats with a face coating obtained from a resin, surfacer, digestive fiber and organic solvent mixture in step 20 such that the hardness of the finished bamboo slat is gained about within 2H to 4H.

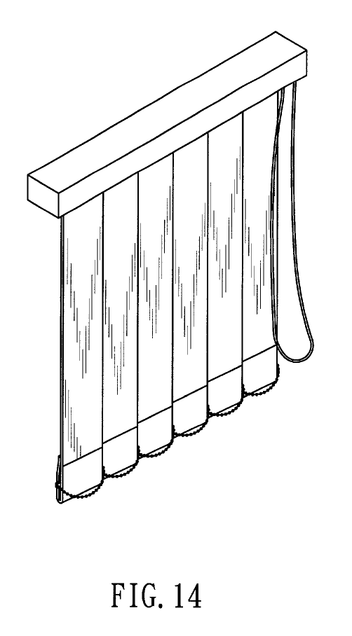

(v) In step 21, the bamboo slat 150 is punched to provide two through holes 151 with a distance F such as about 140 to 150 mm from the edge. Finally, in steps 22 and 23, the through holes 151 are intended to accommodate the pull cords to assemble a Venetian blind as shown in FIGS. 13 and 14.

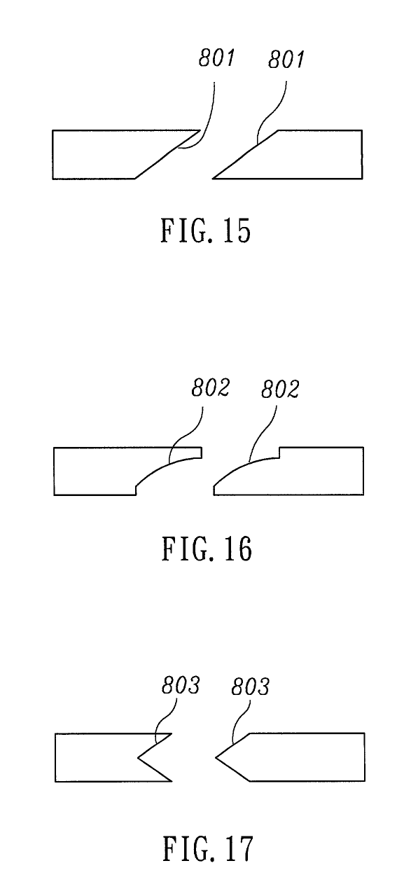

Referring to FIGS. 15 to 17, there show another embodiments for engaging two bamboo strips in above-mentioned step 8 of the present invention. The engagement can be as shown in these figures with shapes like 801, 802 and 803, then two bamboo strips can be also jointed together.

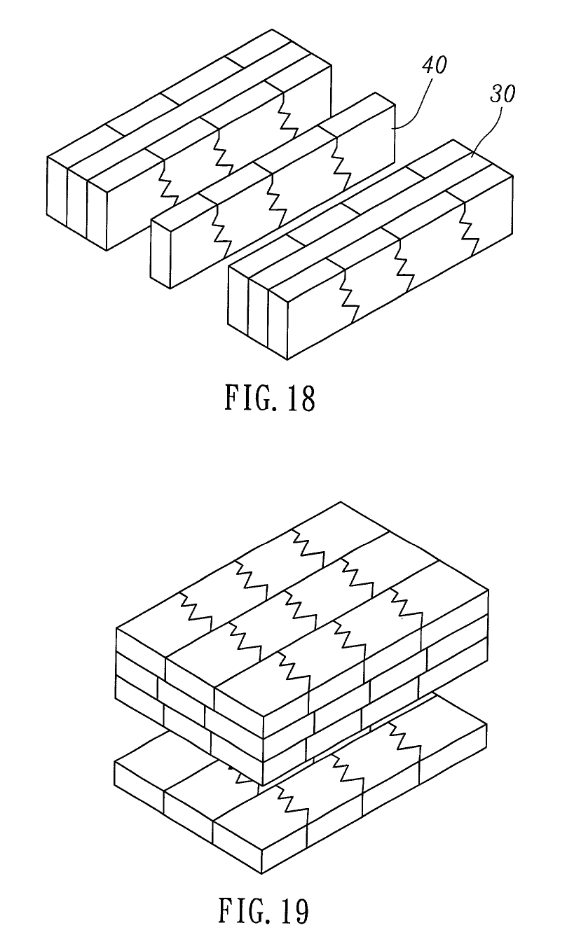

Referring to FIG. 18, in the above-mentioned stacking step 12 of the present invention, there can choose any two of a non-jointed bamboo strip 30 and the jointed bamboo strips 40 in different engagements shown in FIGS. 7A, 7B, 15 to 16 or others to stack into the bamboo plate 130 of FIG. 10.

Finally, please referring to FIG. 19, it can stack twice in the present invention, that is, further with transverse stacking to increase the width D of the bamboo plate 130 as shown in FIG. 10, and thus the fabrication of the bamboo slats can be more efficient.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for fabricating bamboo slats, comprising:
splitting a selected bamboo stem into a plurality of bamboo strips;
successively removing skins and joints, disinfecting and drying the bamboo strips;
jointing at least two bamboo strips with an engagement on each longitudinally corresponding end thereof to obtain a jointed bamboo, and adhering the jointed bamboo strips to obtain a bamboo plate; and
slicing the bamboo plate to obtain the bamboo slats.

2. The method of claim 1 wherein the disinfecting step comprises boiling the bamboo strips in a diluted hydrogen peroxide solution for about 8 hours.

3. The method of claim 1 wherein the bamboo strips are disinfected by a sulfur fume.

4. The method of claim 1 wherein the adhering step further comprises adhering the jointed bamboo strips together in conjunction with a pneumatic press to obtain the bamboo plate.

5. The method of claim 4 further comprising trimming and then polishing the bamboo plate before the slicing step.

6. The method of claim 1 further comprising trimming the bamboo strips before the jointing step.

7. The method of claim 1 wherein the jointing step comprising indenting the longitudinally corresponding end of the bamboo strip for the engagement.

8. The method of claim 1 wherein the jointing step comprising truncating the longitudinally corresponding end of the bamboo strip for the engagement.

9. The method of claim 1 wherein adhering step further comprising stacking the bamboo strips one by one in a staggered arrangement to obtain the bamboo plate.

10. The method of claim 9 wherein the stacking step comprising stacking a non-jointed bamboo strip to obtain the bamboo plate.

11. The method of claim 9 wherein the stacking step comprising transversally stacking the bamboo strips in a staggered arrangement to obtain the bamboo plate.

12. The method of claim 1 further comprising polishing the jointed bamboo strips before the adhering step.

13. The method of claim 1 further comprising covering a base and then a surface coating on the bamboo slats after the slicing step.

14. The method of claim 13 further comprising polishing the bamboo slats between the base and the surface coating steps.

15. The method of claim 13 further comprising punching a cord hole after the coating step.

16. A bamboo blind slat made by a plurality of bamboo strips after split from a bamboo stem, which is obtained by slicing a bamboo plate adhered the bamboo strips together in conjunction with a pneumatic press, wherein the bamboo plate comprises at least two bamboo strips are jointed with an engagement on each longitudinally corresponding end.

17. The slat of claim 16 wherein the engagement is an indented engagement.

18. The slat of claim 16 wherein the engagement is a truncated engagement.
